(19) United States
(12) Patent Application Publication
(10) Pub. No.: US 2010/0075663 A1
(43) Pub. Date: Mar. 25, 2010

(54) METHOD FOR REPORTING A CHANNEL QUALITY INFORMATION IN WIRELESS COMMUNICATION SYSTEM

(76) Inventors: Sung-Cheol Chang, Daejeon-city (KR); Min-Sik Seo, Daejeon-city (KR); Chul-Sik Yoon, Seoul (KR)

Correspondence Address: STAAS & HALSEY LLP, SUITE 700, 1201 NEW YORK AVENUE, N.W., WASHINGTON, DC, 20005, US

(21) Appl. No.: 12/447,422

(22) PCT Filed: Oct. 29, 2007
(86) PCT No.: PCT/KR2007/005359

§ 371 Date: Apr. 27, 2009

(30) Foreign Application Priority Data
Oct. 27, 2006 (KR) 10-2006-0105233
Nov. 8, 2006 (KR) 10-2006-0109730

(51) Int. Cl. H04W 24/00; H04W 72/08; H04B 17/02

(52) U.S. Cl. 455/424; 455/452.2; 455/9

(57) ABSTRACT

Provided is a method of reporting channel quality information in a wireless communication system. A relay station (RS) measures an uplink signal of a mobile station (MS) to obtain a measurement result, and transmits a report message including the measurement result and identification information of the MS to a base station (BS).

### TECHNICAL FIELD

The present invention relates to a wireless communication system, and more particularly, to a method of reporting uplink channel quality information of a mobile station (MS) to a base station (BS) in a relay station (RS).

The present invention is derived from research conducted as a part of “IT New Growing Engine Core Technology Development Projects” promoted by the Ministry of Information and Communication and the Institute for Information Technology Advancement, Republic of Korea [Research Title: WiBro Evolution Standardization].

### BACKGROUND ART

Mobile communication systems suffer from many problems due to a change in a wireless channel that is used to transmit data to mobile terminals. A wireless channel between a transmitter and a receiver changes when a terminal is moved, a frequency band changes, environmental conditions, such as weather conditions or geographic features, change, and so on.

The Institute of Electrical and Electronics Engineers (IEEE) 802.16 Working Group (WG) recommends practices to support the development and deployment of broadband wireless access (BWA) standards, and the IEEE 802.16-2004 standard and IEEE 8 02.16e-2005 standard, which improves upon the IEEE 802.16-2004 standard by adding support for mobility, have been published. The WiMAX forum actively develops both the IEEE 802.16-2004 and IEEE 802.16e-2005 standards and promotes the introduction of broadband wireless access services. The forum addresses not only a wireless standard but also a network standard.

FIG. 1 illustrates a conventional mobile relay system.

Referring to FIG. 1, the mobile relay system includes a base station (BS) 100, a mobile station (MS) 120, and a relay station (RS) 110 relaying a signal between the BS 100 and the MS 120. The MS 120 is compatible with a subscriber station (SS) that is a general terminal. The IEEE 802.16-2004 standard and the IEEE 802.16e-2005 standard are collectively referred to as the 16 standard hereinafter.

According to the BWA standard, the BS 100 allocates wireless resources and controls a procedure for each user in a cell, and the SS or MS 120 transmits a message and data using the resources allocated by the BS 100. The BS 100 broadcasts a MAP control message to indicate the allocated resources for each frame, and the SS or the MS 120 recognizes the allocated resources using downlink (DL) frame information and uplink (UL) frame information included in the broadcast MAP control message. The SS or the MS 120 transmits a media access control (MAC)-protocol data unit (PDU) using the allocated resources.

Currently, IEEE 802.16 suggests a standard for the RS 110 which relays a signal between the BS 100 and the MS 120. A DL refers to the transmission of a signal from the BS 100 to the MS 120 via the RS 110. A UL refers to the transmission of a signal from the MS 120 to the BS 100 via the RS 110.

In FIG. 1, a plurality of RSs 110 may be located between the BS 100 and the MS 120, and in this case, communications between the RSs 110 are also required. The standard for RSs suggested by the IEEE 802.16e is applicable only to communications between the RS 110 and the BS 110, and does not affect the function of the MS 120.

An IEEE 802.16j system including an MS that is compatible with the 16 standard has a problem in that since the MS recognizes only a BS but fails to recognize an additional RS, the MS cannot transmit RS related information to an RS or the BS.

When an MS is moved in a cell of a BS, a plurality of RSs may be located between the BS and the MS. Each of the RSs transmits a signal transmitted by the MS to the BS, and transmits a signal transmitted by the BS or an RS to the MS. Since a wireless channel between the moving MS and the RS changes, the BS allocating wireless resources must always collect information on the changing wireless channel. The BS makes a schedule to determine a modulation and coding scheme (MCS) level and a resource size by using the collected information on the wireless channel.

### DETAILED DESCRIPTION OF THE INVENTION

### Technical Problem

The present invention provides a method of measuring and reporting an uplink signal of a mobile station (MS) to a base station (BS) in a wireless communication system and a message format used in the reporting method.

### Technical Solution

According to an aspect of the present invention, there is provided a method of reporting channel quality in a relay station of a wireless communication system, the method comprising: measuring the quality of an uplink between the relay station and a mobile station; and transmitting a report message including a measurement result and identification information of the relay station to a base station.

According to another aspect of the present invention, there is provided a method of reporting channel quality in a base station of a wireless communication system, the method comprising: receiving from a relay station a report message including quality measurement information of an uplink between the relay station and a mobile station and identification information of the relay station; and selecting a new relay station on the basis of the report message.

According to another aspect of the present invention, there is provided a computer-readable recording medium having embodied thereon a message format for reporting channel quality in a wireless communication system, the computer-readable recording medium comprising: a first identification information field including identification information of a mobile station connected to a relay station; and a channel quality field including information on channel quality measured in regard to an uplink of the mobile station.

### ADVANTAGEOUS EFFECTS

According to the present invention, since an additional control process for transmitting mobile station (MS) information between a relay station (RS), which measures an MS uplink signal, and a base station (BS), which manages MS information, is not necessary, resources can be saved. When the RS reports an MS measurement result, the amount of data reported after filtering can be reduced. A plurality of filtering thresholds can be set and modulation and coding scheme (MCS) levels can be respectively applied to the filtering thresholds.

### DESCRIPTION OF THE DRAWINGS

FIG. 1 illustrates a conventional mobile relay system.

FIG. 2 illustrates a method of reporting an uplink channel measurement result of a mobile station (MS) in a relay station (RS) according to an embodiment of the present invention.

FIG. 3 illustrates a method of reporting an uplink channel measurement result of an MS in an RS according to another embodiment of the present invention.

FIG. 4 illustrates a method of controlling a function of measuring and reporting an uplink signal of an MS in a RS according to an embodiment of the present invention.

FIG. 5 illustrates a duration for which an RS stores information regarding MSs which are subjects of measurement according to an embodiment of the present invention

FIG. 6 illustrates a filtering threshold based on which an RS filters an uplink signal measurement result of an MS according to an embodiment of the present invention.

FIG. 7 illustrates a filtering threshold based on which an RS filters an uplink signal measurement result of an MS according to another embodiment of the present invention.

FIG. 8 illustrates hysteresis defined by a filtering threshold according to an embodiment of the present invention.

FIG. 9 illustrates a method of erasing MS information stored in an RS according to an embodiment of the present invention.

FIG. 10 illustrates a method of selecting an RS on the basis of an uplink signal measurement result of an MS according to an embodiment of the present invention.

FIG. 11 illustrates a method of measuring and reporting a signal of an adjacent RS source in an RS according to an embodiment of the present invention.

FIGS. 12A and 12B illustrate a message transmitted by an RS to a base station (BS) to report a signal measurement result according to an embodiment of the present invention.

FIG. 13 illustrates a measurement request message transmitted by a BS to the RS in the method of FIG. 4 according to an embodiment of the present invention.

FIG. 14 illustrates a measurement response message transmitted by the RS to the BS in the method of FIG. 4 according to an embodiment of the present invention.

FIG. 15 illustrates an MS measurement threshold defined by an uplink channel descriptor (UCD) according to an embodiment of the present invention.

FIG. 16 illustrates a method of reporting an uplink signal measurement result of an MS in an RS according to an embodiment of the present invention.

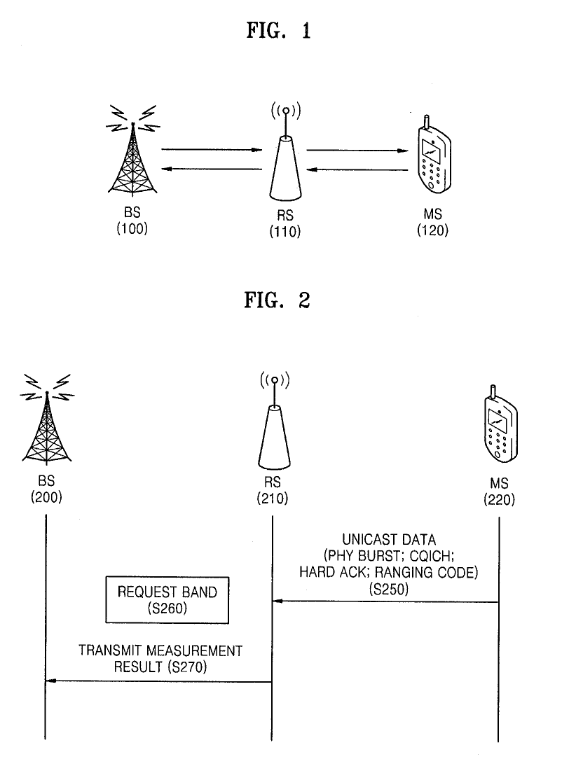

### BEST MODE

According to an aspect of the present invention, there is provided a method of reporting channel quality in a relay station (RS) of a wireless communication system, the method comprising:measuring the quality of an uplink between the RS and a mobile station (MS); and transmitting a report message including a measurement result and identification information of the RS to a base station (BS).

According to another aspect of the present invention, there is provided an RS of a wireless communication system, the RS comprising: a quality measuring unit measuring the quality of an uplink between the RS and an MS to obtain measurement information; and a message transmitting unit transmitting a report message including the measurement information and identification information of the MS to a BS.

According to another aspect of the present invention, there is provided a computer-readable recording medium having embodied thereon a message format for reporting channel quality in a wireless communication system, the computer-readable recording medium comprising: a first identification information field including identification information of an MS connected to an RS; and a channel quality field including information on channel quality measured in regard to an uplink of the MS.

### MODE OF THE INVENTION

The present invention will now be described more fully with reference to the accompanying drawings, in which exemplary embodiments of the invention are shown.

FIG. 2 illustrates a method of reporting an uplink channel measurement result of a mobile station (MS) 220 to a base station (BS) 200 in a relay station (RS) 210 according to an embodiment of the present invention.

Referring to FIG. 2, in operation S250, the RS 210 measures the quality of unicast data transmitted from the MS 220 through an uplink between the RS 210 and the MS 220. In operation S260, the RS 210 requests the BS 200 for a band and is assigned the band. In operation S270, the RS 210 transmits a measurement result to the BS 200. Here, examples of the unicast data include a physical (PHY) burst, a channel quality indicator channel (CQICH), a hybrid automatic repeat request (HARQ) acknowledgement (ACK), and ranging codes.

For example, it is assumed that a CQICH is measured. Once the MS 220 is allocated the CQICH from the BS 200, the MS 220 transmits a downlink wireless channel measurement result. The RS 210 measures the strength of the downlink wireless channel measurement result received from the MS 220, and reports a measurement result to the BS 200. Hence, by using the CQICH, the BS 200 or the RS 210 can make the MS 220 transmit the channel measurement result at a desired point of time. In detail, once the BS 200 allocates the CQICH to the MS 220 using an UL-MAP, the MS 220 following the 16 standard transmits a measurement result of the allocated CQICH to the RS 210. The RS 210 receiving the measurement result of the CQICH from the MS 220 can determine the strength of the received measurement result. Since the same CQICH is transmitted by the MS 220, an RS 210 determining the highest strength is assumed to have the best wireless channel between the MS 220 and the RS 210.

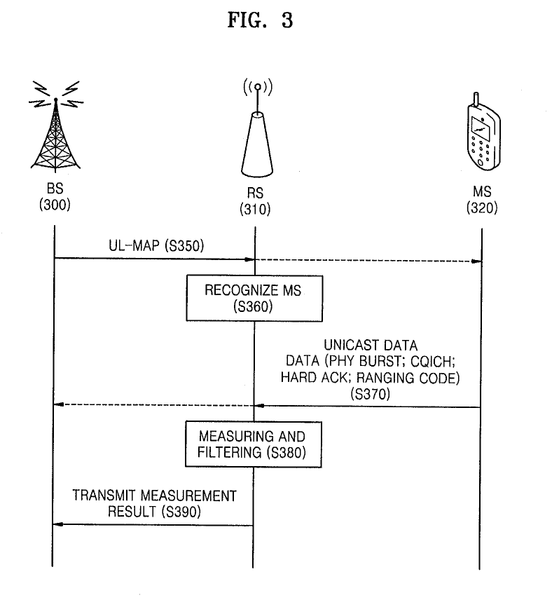

FIG. 3 illustrates a method of reporting an uplink channel measurement result of an MS 320 to a BS 300 in an RS 310 according to another embodiment of the present invention.

Referring to FIG. 3, in operation S350, the RS 310 receives a UL-MAP from the BS 300. In operation S360, the RS 310 recognizes resource information and resource user information, which is about resource users, i.e., MSs, using the UL-MAP received from the BS 300. A MAP is resource allocation information in a frame, a downlink-MAP (DL-MAP) is resource information allocated to a downlink region in the MAP, and a UL-MAP is resource information allocated to an uplink region in the MAP. That is, the RS 310 recognizes the resource information allocated to the MSs and positions of the MSs using the UL-MAP.

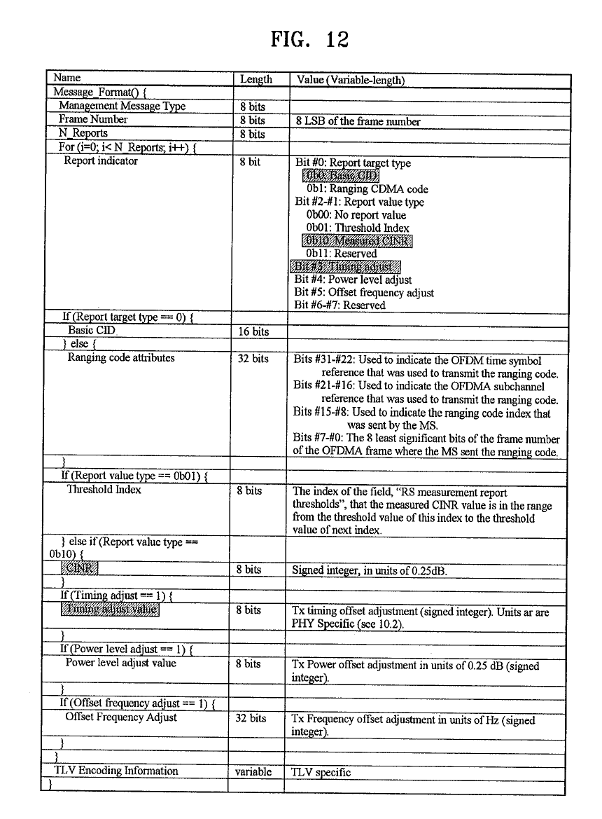

In operation S370, the RS 310 receives a signal, for example, unicast data, from the recognized MS 320. In operation S380, the RS 310 measures the quality of the signal received from the MS 320. In operation S390, the RS 310 transmits a measurement result to the BS 300 if the measurement result corresponds to a preset threshold. A filtering process for determining whether the measurement result corresponds to the preset threshold will be explained later in detail with reference to FIG. 6. An example of a report message, transmitted by the RS 310 to the BS 300, for reporting the measurement result to the BS 300 is shown in FIGS. 12A and 12B.

When transmitting measurement information to a BS, an RS transmits only information required by the BS by filtering, thereby minimizing wireless resource allocation. That is, since the BS changes wireless channel resources using the measurement information transmitted by the RS, the RS transmits only information necessary for determining whether to change the wireless channel resources to the BS.

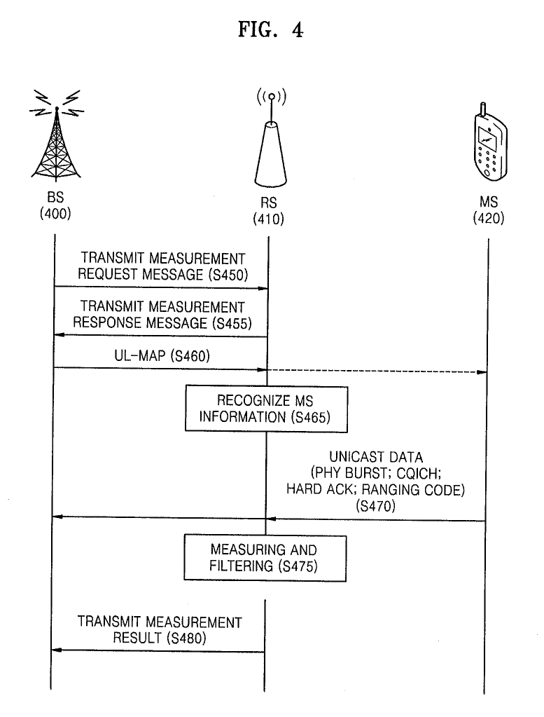

FIG. 4 illustrates a method of controlling a function of measuring and reporting an uplink signal of an MS 420 in an RS 410 according to an embodiment of the present invention.

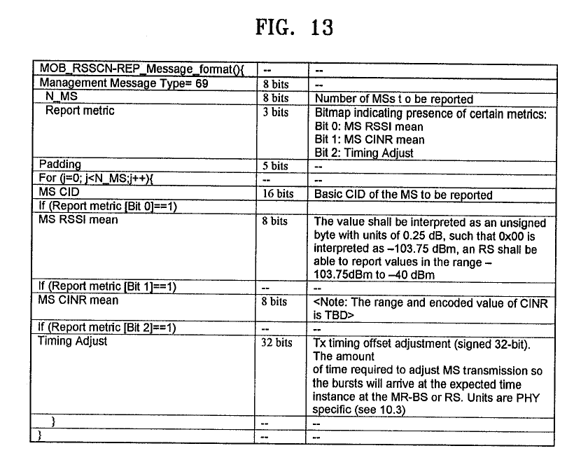

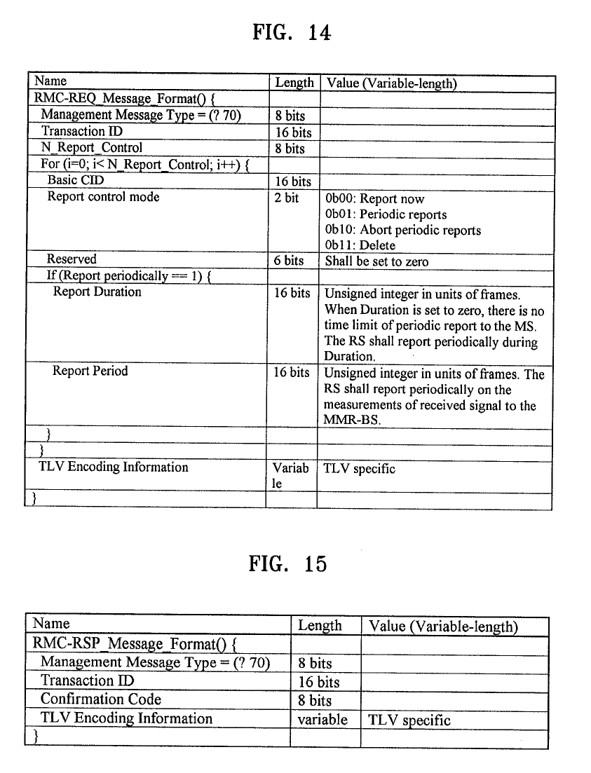

Referring to FIG. 4, in operation S450, a BS 400 transmits a measurement request message requesting the RS 410 to measure and report the uplink signal of the MS 420. In operation S455, the RS 410 transmits to the BS 400 a measurement response message to acknowledge the receiving of the measurement request message. Here, the measurement request message may include information regarding a duration from when the function of measuring and reporting the uplink signal of the MS 420 starts to when the function of measuring and reporting the uplink signal of the MS 420 ends, information regarding a cycle of the function of measuring the uplink signal of the MS 420, or information necessary for requesting to measure an uplink signal of a specific MS. Of course, the BS 400 can control the RS 410 in various ways to report a measurement result of the uplink signal. In operation S460, the RS 410 receives a UL-MAP from the BS 400. In operation S465, the RS 410 recognizes resource information and resource user information using the UL-MAP received from the BS 400. In operations S470 through S480, the RS received the measurement request message measures the uplink signal of the BS 400, and reports the measurement result to the BS 420. The operations S460 through S480 are the same as the operations of FIG. 3. Examples of the measurement request message and the measurement response message are shown in FIGS. 13 and 14.

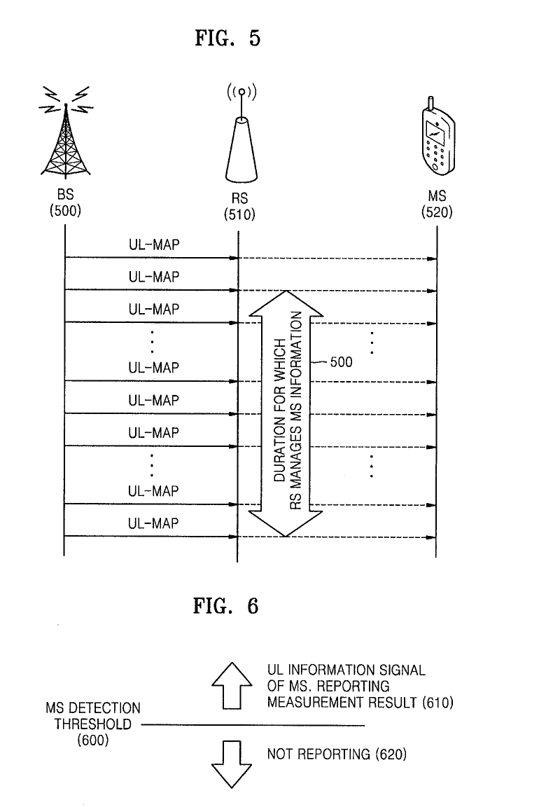

FIG. 5 illustrates a duration for which an RS 510 stores information regarding MSs 520, which are subjects of measurement, according to an embodiment of the present invention.

Referring to FIG. 5, the RS 510 measures an uplink signal of each of the MSs recognized using UL-MAPS received from a BS 500, and if a measurement result is higher than a predetermined filtering threshold, the RS 510 reports information of the MS 520 to the BS 500, and stores the information of the MS 520. If the signal measurement result of the uplink of the MS 520 belongs to a filtering region to which a latest measurement result reported to the BS 500 belongs, the RS 510 stores the measurement result but does not report the measurement result to the BS 500. If the signal measurement result of the uplink signal of the MS 520 does not belong to the filtering region to which the previous measurement result belongs, the RS 510 reports the measurement result to the BS 500 and the RS 510 stores the measurement result. However, if there is no traffic in the uplink of a specific MS 520 for a predetermined period of time, the RS 510 erases information of the specific MS 520.

FIG. 6 illustrates a filtering threshold based on which an RS filters an uplink signal measurement result of an MS according to an embodiment of the present invention.

Referring to FIG. 6, the RS shares an MS detection threshold 600 with a BS. When the BS transmits the MS detection threshold as broadcasting information to the RS, or the BS sets the MS detection threshold in a procedure of configuring the RS, the RS and the BS can share the MS detection threshold.

If the uplink signal measurement result of the MS is higher than the MS detection threshold 600, the RS reports the measurement result to the BS. The fact that the measurement result is higher than the MS detection threshold 600 means that the RS can receive a signal, whereas the fact that the measurement result is lower than the MS detection threshold 600 means that the RS cannot receive a signal. Accordingly, if the uplink signal measurement result of a specific MS and a previous measurement result belong to different regions on the basis of the MS detection threshold, the RS reports the uplink signal measurement result to the BS.

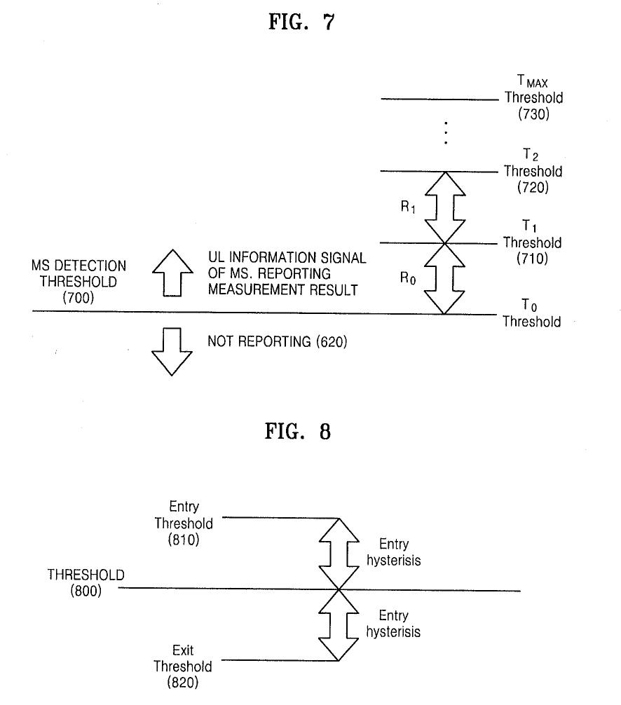

FIG. 7 illustrates a filtering threshold based on which an RS filters an uplink signal measurement result of an MS according to another embodiment of the present invention.

Referring to FIG. 7, the RS may divide a region over an MS detection threshold 700 into a plurality of regions 710, 720, and 730. For example, thresholds T₀ 700, T₁ 710, T₂ 720, through to Tₘₐₓ 730 are set to boundaries of the regions over the MS detection threshold 700, and then the RS determines to what region the uplink signal measurement result of the MS belongs. The RS reports the signal measurement result only when the uplink signal measurement result of the MS does not belong to a region to which a previous measurement result belongs. That is, since the signal measurement result is reported to a BS only when the uplink signal measurement result of the MS does not belong to the region to which the previous measurement result belongs, the amount of information reported to the BS can be reduced as compared with that of FIG. 6. The BS may set a modulation and coding scheme (MCS) level depending on the strength of the uplink signal measurement result of the MS. For example, if the uplink signal measurement result of the MS belongs to a region R₀ between T₀ 700 and T₁ 710, the BS selects a first MCS level and allocates wireless resources, and if the uplink signal measurement result of the MS belongs to a region R₁ between T₁ 710 and T₂ 720 (R₁), the BS selects a second MCS level and allocates wireless resources. The 16 standard defines a normalized carrier to noise ratio (C/N) with respect to uplink interval usage codes (UIUCs) or downlink interval usage codes (DIUCs), and defines a normalized C/N override field in order to correct the normalized C/N according to each BS. The RS uses the “normalized C/N” and the “normalized C/N override” fields defined in the 16 standard in order to set a threshold.

FIG. 8 illustrates hysteresis defined by a filtering threshold according to an embodiment of the present invention.

Referring to FIG. 8, when one threshold 800 is set and an uplink signal measurement result of an MS is changed around the threshold 800, an RS reports the measurement result to a BS. In order to prevent this, the concept of hysteresis is introduced. That is, an entry hysteresis 810 and an exit hysteresis 820 are defined on the basis of the threshold 800. If the uplink signal measurement result of the MS is changed from a region below the threshold 800 to a region above the threshold 800, an entry threshold 810 is used, and if the uplink signal measurement result of the MS is changed from a region above the threshold 800 to a region below the threshold 800, an exit threshold 820 is used.

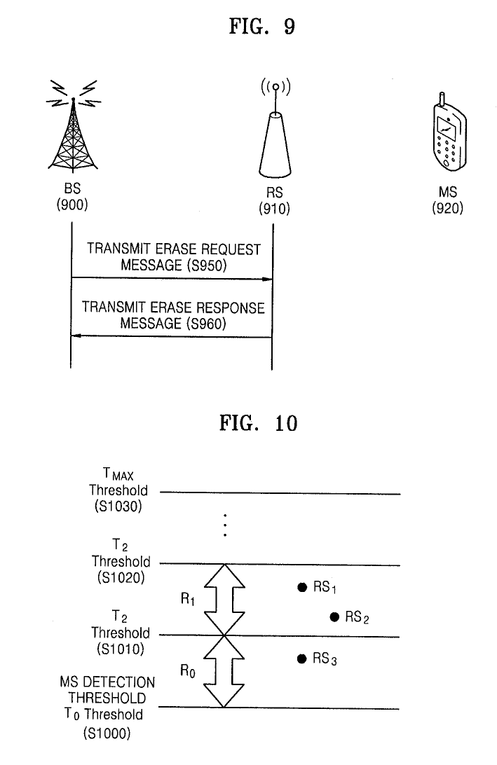

FIG. 9 illustrates a method of erasing MS information stored in an RS 910 according to an embodiment of the present invention.

Referring to FIG. 9, the RS 910 stores MS information of an MS 920 for a predetermined period of time. However, if it is determined that the MS 920 is moved out of a cell of the RS 910 or is less likely to enter the cell of the RS 910, a BS 900 requests the RS 910 to erase the MS information managed by the RS 910. In detail, in operation S950, the BS 900 transmits to the RS 910 an erase request message including information of MSs which are subjects of erasure. In operation S960, the RS transmits an erase response message to the BS.

In addition, the RS 910 may analyze control messages exchanged between the BS 900 and the MS 920 and change the MS information. For example, the RS 910 obtains MS message added to a ranging response (RNG-RSP) message, and obtains MS information erased from a de/re-register command (DREG-CMD) message. Also, the RS 910 analyzes messages related to a handover procedure and thus obtains MS information of an MS moved to another cell.

FIG. 10 illustrates a method of selecting an RS on the basis of an uplink signal measurement result of an MS according to an embodiment of the present invention.

Referring to FIG. 10, a plurality of thresholds 1000, 1010, 1020, and 1030 for filtering the uplink signal measurement result of the MS are set as described in FIG. 7. A BS receives a measurement result of an uplink signal measurement result of a specific MS from a plurality of RSs, for example, RS₁, RS₂, and RS₃. The uplink signal measurement result of the MS received from each of the RS₁ and RS₂ belongs to a region R₁, and the uplink signal measurement result of the MS received from the RS₃ belongs to a region R₀. Accordingly, if the BS selects an MCS level corresponding to the region R₁, the RS₁ and the RS₂ are selected as RSs relaying an MS signal. If an MCS level corresponding to the region R₀ is selected, the RS₃ is selected as an RS relaying an MS signal.

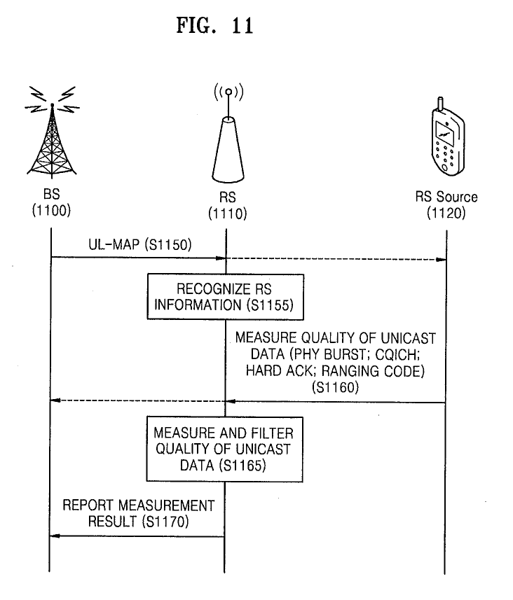

FIG. 11 illustrates a method of measuring and reporting a signal of an adjacent RS source 1120 in an RS 1110 according to an embodiment of the present invention.

Referring to FIG. 11, the RS 1110 does not measure a unicast signal received from an MS but measures a signal received from the adjacent RS source 1120, and reports the measurement result. In detail, in operation S1150, the RS 1110 receives a UL-MAP from a BS 1100. In operation S1155, the RS 1110 recognizes information regarding resource users, i.e., adjacent RS sources, and resources allocated by the BS 1100 using the UL-MAP. In operation S1160, the RS 1110 receives unicast data from the adjacent RS source 1120. In operation S1165, the RS 1110 measures the unicast data to obtain a measurement result. In operation S1170, the RS 1110 reports the measurement result to the BS 1100 if the measurement result is higher than a predetermined threshold.

FIGS. 12A and 12B illustrate a message transmitted by an RS to a BS to report a signal measurement result according to an embodiment of the present invention.

Referring to FIGS. 12A and 12B, a measurement report message illustrated in each of FIGS. 12A and 12B includes a media access control (MAC) header including a basic communication identifier (CID) of an RS, basic CIDs of MSs which are subjects of measurement, a measured carrier to interference and noise ratio (CINR), and a timing adjust value. In FIG. 12B, the measurement result includes a received signal strength indicator (RSSI).

In addition, the measurement report message of FIG. 12A includes adjustment values such as ranging code attributes for identifying a code division multiple access (CDMA) code, a power level, and an offset frequency.

FIG. 13 illustrates a measurement request message transmitted by the BS to the RS in the method of FIG. 4 according to an embodiment of the present invention. FIG. 14 illustrates a measurement response message transmitted by the RS to the BS in the method of FIG. 4 according to an embodiment of the present invention.

FIG. 15 illustrates an MS measurement threshold defined by an uplink channel descriptor (UCD). Referring to FIG. 15, a plurality of thresholds required in filtering and a duration for which an RS maintains MS information are defined using the UCD.

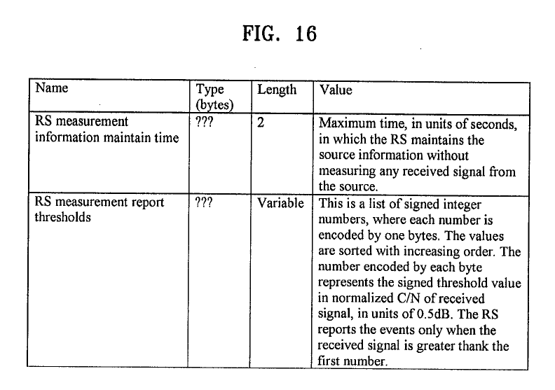

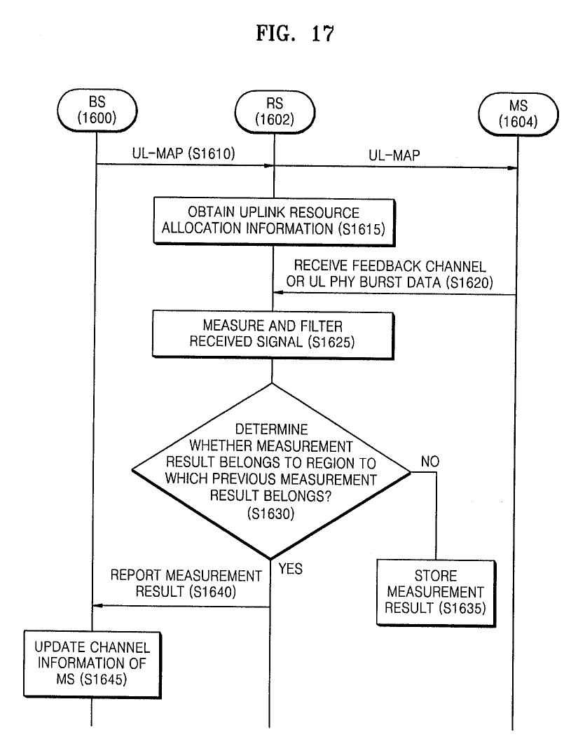

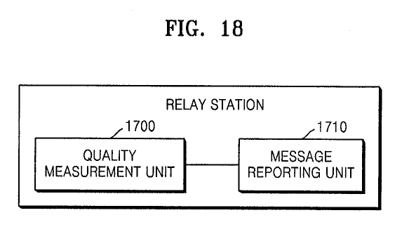

FIG. 16 illustrates a method of reporting an uplink signal measurement result of an MS 1604 in an RS 1602 according to an embodiment of the present invention.

Referring to FIG. 16, in operation S1610, the RS 1062 receives a UL-MAP from a BS 1600. In operation S1615, the RS 1062 recognizes MSs 1604 which are subjects of measurement using the UL-MAP. That is, in operation S1615, the RS 1602 obtains uplink resource allocation information of the MSs which are subjects of measurement. In operation S1620, the RS 1062 receives data from the MS 1604. In operation S1625, the RS 1602 measures a signal of the data received from the MS 1604. In operation S1630, it is determined whether a measurement result belongs to a region to which is a previous measurement result belongs on the basis of a filtering threshold shown in FIGS. 6 through 8. If it is determined in operation S1630 that the measurement result does not belong to the region to which the previous measurement result belongs, the method proceeds to operation S1640. In operation S1640, the RS 1602 reports the measurement result to the BS 1600. If it is determined in operation S1630 that the measurement result belongs to the region as the region to which the previous measurement result belongs, the method proceeds to operation S1635. In operation S1635, the RS 1602 does not report the measurement result to the BS 1600 and the RS 1602 stores the measurement result. In operation S1645, the BS 1600 updates channel information of the MS 1604 using the reported measurement result.

The present invention may be embodied as computer readable codes on a computer readable recording medium. The computer readable recording medium is any data storage device that can store data which can be thereafter read by a computer system. Examples of the computer readable recording medium include read-only memories (ROMs), random-access memories (RAMs), CD-ROMs, magnetic tapes, floppy disks, and optical data storage devices. The computer readable recording medium can be dispersively installed in a computer system connected to a network, and stored and executed as a computer readable code in a distributed computing environment.

While the present invention has been particularly shown and described with reference to exemplary embodiments thereof, it will be understood by those of ordinary skill in the art that various changes in form and detail may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

1. A method of reporting channel quality in a relay station of a wireless communication system, the method comprising:
measuring the quality of an uplink between the relay station and a mobile station; and
transmitting a report message including a measurement result and identification information of the relay station to a base station.

2. The method of claim 1, wherein the measuring of the quality comprises measuring the quality of an uplink between two or more mobile stations connected to the relay station,
wherein the transmitting of the report message comprises transmitting a report message including identification information of the relay station, identification information of the two or more mobile stations, and measurement information of the uplink between the two or more mobile stations.

3. The method of claim 1, wherein the measuring of the quality comprises measuring at least one of a received signal strength indicator (RSSI), a carrier to interference and noise ratio (CINR), and a timing adjust value with respect to the uplink.

4. The method of claim 1, further comprising receiving a transmission request of the report message from the base station.

5. The method of claim 1, wherein the transmitting of the report message comprises transmitting the report message if the measurement result is higher than a preset threshold.

6. The method of claim 1, wherein the transmitting of the report message comprises transmitting the report message if the measurement result does not belong to a region, to which a previous measurement result belongs, among regions divided by a plurality of preset thresholds.

7. The method of claim 1, wherein the transmitting of the report message comprises transmitting the report message if a difference between the measurement result and a previous measurement result is higher than a predetermined value.

8. A method of reporting channel quality in a base station of a wireless communication system, the method comprising:
receiving from a relay station a report message including quality measurement in formation of an uplink between the relay station and a mobile station and identification information of the relay station; and
selecting a new relay station on the basis of the report message.

9. The method of claim 8, wherein the report message includes identification information of the relay station, identification information of two or more mobile stations connected to the relay station, and quality measurement information of an uplink between the two or more mobile stations.

10. The method of claim 8, further comprising requesting a transmission of the report message to the relay station.

11. The method of claim 8, further comprising updating resource allocation to the mobile station on the basis of the report message.

12. A computer-readable recording medium having embodied thereon a message format for reporting channel quality in a wireless communication system, the computer-readable recording medium comprising:
a first identification information field including identification information of a mobile station connected to a relay station; and
a channel quality field including information on channel quality measured on an uplink of the mobile station.

13. The computer-readable recording medium of claim 12, further comprising a second identification information field including identification information of the relay station.

14. The computer-readable recording medium of claim 12, wherein the channel quality field includes at least one of an RSSI, a CINR, and a timing adjust value with respect to the uplink.
